(19) United States
(12) Patent Application Publication
(10) Pub. No.: US 2014/0062427 A1
(43) Pub. Date: Mar. 6, 2014

(54) ULTRA LOW RIPPLE BOOST CONVERTER

(71) Applicant: Fairchild Semiconductor Corporation, San Jose, CA (US)

(72) Inventors: Edward Paul Coleman, Salt Springs, FL (US); Juha Joonas Oikarinen, Santa Clara, CA (US)

(73) Assignee: Fairchild Semiconductor Corporation, San Jose, CA (US)

(21) Appl. No.: 14/015,874

(22) Filed: Aug. 30, 2013

Related U.S. Application Data
(60) Provisional application No. 61/696,061, filed on Aug. 31, 2012.

(51) Int. Cl. G05F 1/614

(52) U.S. Cl. CPC G05F 1/614
USPC 323/233

(57) ABSTRACT

This document discusses, among other things, systems and methods including a boost converter configured to receive an input voltage (e.g., a battery voltage) and to provide a boosted output voltage higher than the input voltage, and a shunt regulator coupled to the output of the boost converter through a resistive element and configured to regulate an output ripple of the boosted output voltage. In an example, using the systems and methods described herein, a battery voltage of less than 5 volts can be boosted and regulated to an output voltage between 16 and 20 volts with an output ripple of less than 500 microvolts.

### CLAIM OF PRIORITY

This application claims the benefit of priority under 35 U.S.C. §119(e) of Edward P. Coleman et al. U.S. Provisional Patent Application Ser. No. 61/696,061, titled “ULTRA LOW RIPPLE BOOST CONVERTER,” filed on Aug. 31, 2012 (Attorney Docket No. 2921.330PRV), which is incorporated by reference herein in its entirety.

### BACKGROUND

A boost converter is a circuit configured to provide an output voltage greater than its input voltage. Typically, boost converters include one or more switched energy storage devices that provide a ripple at the output voltage. Various circuits have been used to reduce the output ripple. For example, to reduce the output ripple, boost converters can include a capacitor at the output or can otherwise include a low-dropout (LDO) regulator at the output to provide a stable output voltage. However, current capacitive and LDO solutions are not sufficient for ultra-low ripple applications (e.g., less than 500 microvolts).

FIG. 1 illustrates generally an example of a boost converter 105 coupled to a low-dropout regulator (LDO) 110. However, such a system cannot achieve ultra-low output ripple levels (e.g., less than 500 microvolts).

### Overview

This document discusses, among other things, systems and methods including a boost converter configured to receive an input voltage (e.g., a battery voltage) and to provide a boosted output voltage higher than the input voltage, and a shunt regulator coupled to the output of the boost converter through a resistive element and configured to regulate an output ripple of the boosted output voltage. In an example, using the systems and methods described herein, a battery voltage of less than 5 volts can be boosted and regulated to an output voltage between 16 and 20 volts with an output ripple of less than 500 microvolts.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example of a boost converter coupled to a low-dropout regulator (LDO).

FIG. 2 illustrates generally an example ultra-low ripple boost converter with efficient architecture configured to deliver an output voltage with ultra-low ripple.

FIG. 3 illustrates generally an example ultra-low ripple boost converter including a boost DC-DC converter, a shunt regulator, and output filter.

FIG. 4 illustrates generally example portions of the ultra-low ripple boost converter of FIG. 3.

### DETAILED DESCRIPTION

The present inventors have recognized, among other things, an efficient architecture configured to deliver an output voltage with ultra-low ripple. The efficient architecture can refer to size efficiency, as the circuits herein can use 0402/0201 case size capacitors or inductors and can have a 4.18 mm² solution size, as well as power efficiency, using efficient boost and voltage regulation. In certain examples, the architecture disclosed herein can be configured to provide a 16V-20V output voltage with an ultra-low output ripple. In an example, the ultra-low output ripple can be defined as a maximum 500 uV ripple, and in certain examples, can be lower. For example, with an output voltage of 16V-20V, the architecture disclosed herein can provide a 26 uV ripple with a 3 mA load.

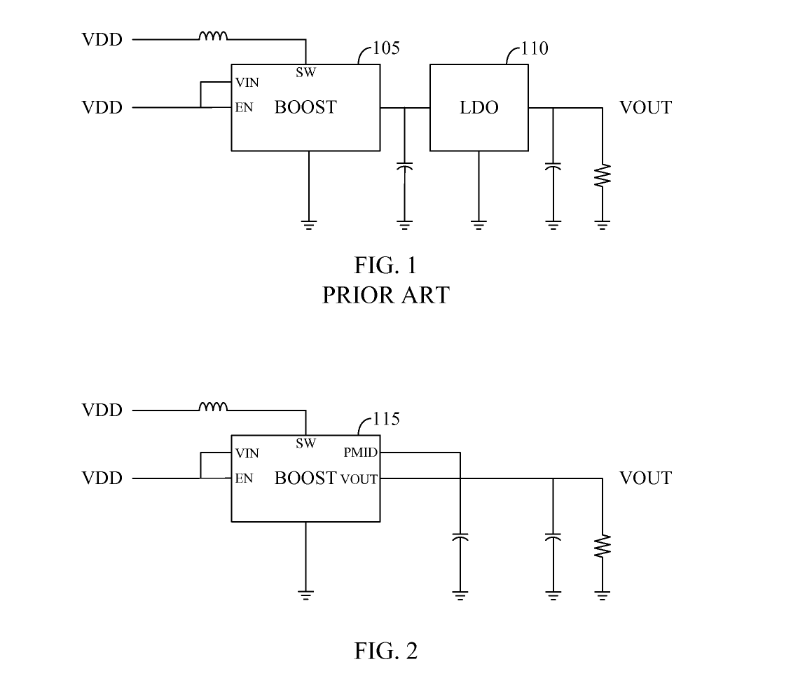

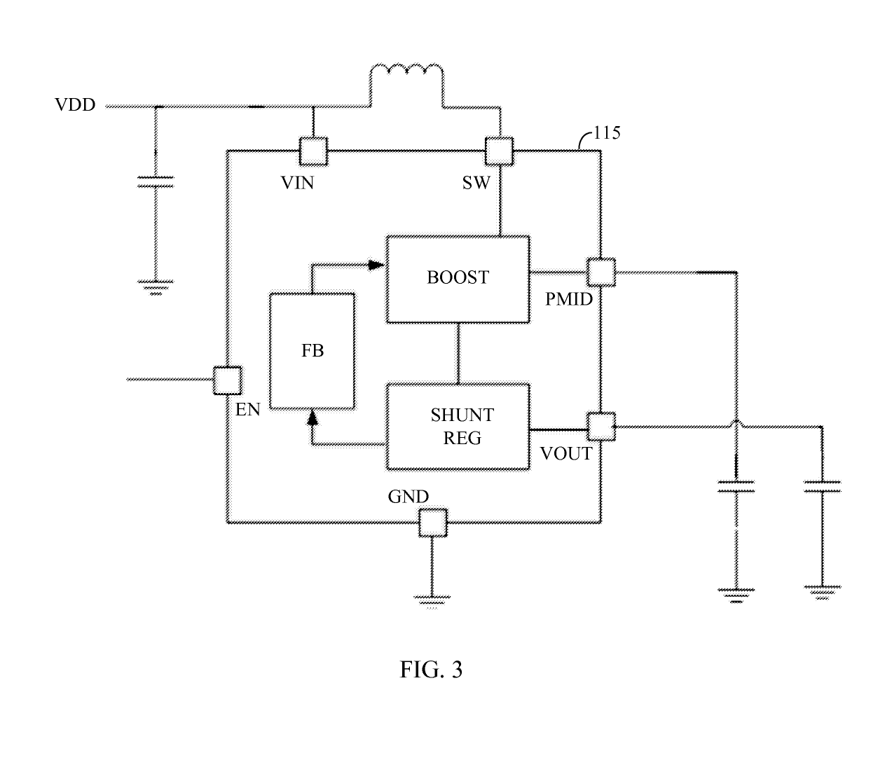

FIG. 2 illustrates generally an example ultra-low ripple boost converter with efficient architecture configured to deliver an output voltage with ultra-low ripple. In an example, the filter caps can include 0402 case size capacitors with 70 nF out and 100 mOhm equivalent series resistance (ESR).

In an example, the ultra-low ripple boost converter can combine a boost DC-DC converter with an RC filter and a shunt regulator to achieve an ultra-low output ripple (e.g., less than 500 uV). Current levels in the shunt regulator can provide feedback to the boost DC-DC converter. In this example, an error amplifier loop is not required for DC regulation in the boost DC-DC converter. A constant shunt output impedance can be used to shift an RC pole to a higher frequency to maintain stability. A low output voltage ripple can be maintained by forming an impedance divider from the series R element in the RC filter and the impedance of the shunt output.

A second shunt at an output of the boost DC-DC converter can be configured as an active capacitor to reduce electromagnetic interference (EMI) spikes, which can permit the boost output filter capacitor to be remote from the boost DC-DC converter.

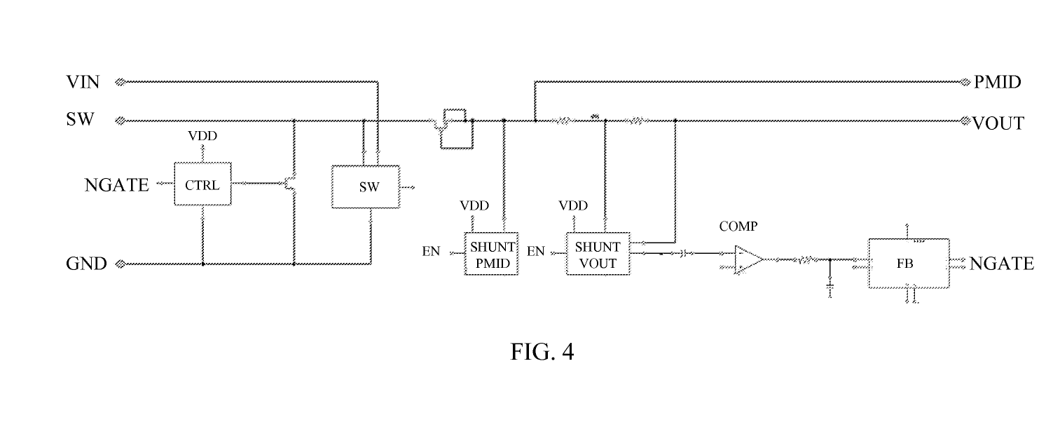

FIG. 3 illustrates generally an example ultra-low ripple boost converter 115 including a boost DC-DC converter, a shunt regulator (e.g., a 16V regulator), and output filter configured to provide, for example, a 16V output source from a 3V input with superior rejection of the switching noise and parasitic ringing due to switch edges. FIG. 4 illustrates generally example portions of the ultra-low ripple boost converter of FIG. 3.

The example topology illustrated in the example of FIG. 3 can provide less than 1 mV of switching frequency ripple with a switching frequency of 2 MHz, and approximately 10 mV of high frequency ringing at switch transition edges.

In an example, the ultra-low ripple boost converter can include a 4-bump WLCSP package, an inductor, two 0402 case size capacitors, and a 400 Ohm resistor. Estimated power efficiency is 80% at 3 mA output load. Superior ripple rejection can be achieved with the combination of a boost converter LC filter cascaded with a passive RC filter. Feedback control (e.g., comparing the shunt current to a threshold) of the boost converter in combination with the shunt regulator can provide a well regulated and stable output under all load conditions.

Stability can be achieved with a series-shunt regulator topology. The series source can be provided by the boost DC-DC converter driving a 400 Ohm external resistor. The shunt element can include a HV PMOS device driven by a dual path feedback system. The high gain path can be dominant at low frequencies, and the low gain high speed path can be dominant at high frequencies, which can provide a shunt regulator that is immediately responsive to output changes. Further, this high speed shunt regulator can provide low output impedance, which can push the output RC filter pole to a higher frequency. Combining the passive RC filter with the shunt regulator at the output can provide wideband ripple rejection up to the bandwidth of the shunt stage, but limited in gain peaking by the passive RC filter, which dominates at high frequencies. The combination can permit a simple compensator to be used for the boost stage, which is the auxiliary feedback loop in the system.

The boost stage can be responsive to the changes in the shunt current, which are dynamic in response to load demand and ripple at the output. The output of the boost stage can be set to 17.2V average at 3 mA load. The boost DC-DC regulator can provide the output required to provide the average load current through the external filter resistor. A 400 Ohm resistor can be used to achieve a balance between the output ripple, process voltage limitations, and load current demand. In other examples, other resistances can be selected with varying effects.

When a load step is encountered, the shunt element can respond by reducing the shunt current level, which can be sensed by the boost DC-DC controller comparator and can trigger the start of a charge cycle, increasing the current level in the inductor. The inductor current can be sensed via the source path in the charge switch and can provide negative feedback to the comparator sense node. The maximum current level of a given charge period can be limited to I=165 mV/100 mOhm or 1.65 A at start-up, and 700 mA typically for steady-state operation.

Once the inductor current reaches the target value, the charge cycle can be terminated and the transfer cycle can begin. The transfer cycle can include a constant off time period. Once a burst of charge cycles occur, the off time can be extended to enable a pulse-frequency modulation (PFM) mode, which can happen when the shunt current exceeds nominal levels (333 uA), and the converter has to wait for the boost supply to decay or for an increase in load demand.

In an example, a voltage regulator can include an asynchronous boost DC-DC converter and a series shunt regulator controlled by an AC coupled GM for shunt regulator, enabling low voltage implementation of a high bandwidth GM and referencing to a low voltage bandgap. The voltage regulator can include a load disconnect switch configured to provide a modulated resistance and an ability disconnect load when the voltage regulator is shut down. The boost implementation can be based on a fixed peak current modulation (N on until reference threshold crossed), and the loop can be forced to DCM mode by min Toff (˜600 ns). In certain examples, the voltage regulator can utilize fixed clock modulation.

The boost DC-DC converter can regulate the current of the shunt regulator, and the shunt resistance of the shunt regulator can be enhanced by a difference in PMID and VOUT. The shunt regulator can provide high frequency rejection, and PMID can be kept Vt above VOUT at light loads.

In an example, with a 3 mA load, a 16V output voltage, and 70 nF effective Cout and Cmid, the output ripple is less than 500 uV and is negligible after the RC filter. In another example, at a boost output of 18.25V, a shunt resistance of 600 ohms, a shunt current of 600 uA, and a 3 mA DC load, the output voltage ripple can be 26 uV.

### Additional Notes

In Example 1, an apparatus configured to provide an ultra-low ripple boosted output voltage can include a boost converter configured to receive an input voltage and to provide a boosted output voltage and a shunt regulator coupled to the output of the boost converter through a resistive element, the shunt regulator configured to regulate an output ripple of the boosted output voltage.

In Example 2, the apparatus of Example 1 can optionally include the resistive element, wherein the resistive element optionally includes a passive resistive element including a first terminal and a second terminal, wherein the boost converter optionally includes an input configured to receive a battery voltage and an output configured to provide the boosted output voltage using an inductor, wherein the output of the boost converter is optionally coupled to the first terminal of the resistive element, and wherein a first terminal of the shunt regulator is optionally coupled to the second terminal of the resistive element.

In Example 3, any one or more of Examples 1-2 optionally includes a resistor-capacitor (RC) circuit coupled to the shunt regulator, wherein the RC circuit is optionally configured to filter the boosted output voltage and optionally includes the resistive element.

In Example 4, the RC circuit of any one or more of Examples 1-3 optionally includes a filter capacitor, wherein the boost converter of any one or more of Examples 1-3 is optionally coupled to an inductor and a boost capacitor and is optionally configured to receive an input voltage from a battery less than 5 volts and to provide a boosted output voltage greater than 15 volts, and wherein the shunt regulator of any one or more of Examples 1-3 is optionally configured to reduce a ripple of the boosted output voltage to be less than 500 microvolts.

In Example 5, the boost capacitor and the filter capacitor of any one or more of Examples 1-4 are optionally at least one of 0402 or 0201 case size components, wherein 0402 case size components have a dimension of 0.6 mm by 0.3 mm and 0201 case size components have a dimension of 1.0 mm by 0.5 mm.

In Example 6, the inductor of any one or more of Examples 1-5 is optionally at least one of a 0402 or a 0201 case size component.

In Example 7, any one or more of Examples 1-6 optionally includes a feedback circuit configured to control the boost converter using information from the shunt regulator.

In Example 8, the feedback circuit of any one or more of Examples 1-7 optionally includes a comparator configured to compare a current through the shunt regulator to a reference.

In Example 9, the ultra-low ripple boosted output voltage of any one or more of Examples 1-8 optionally includes an output voltage between 16 and 20 volts with a ripple less than 500 microvolts.

In Example 10, a method for providing an ultra-low ripple boosted output voltage includes receiving an input voltage and providing a boosted output voltage using a boost converter and regulating an output ripple of the boosted output voltage using a shunt regulator coupled to the output of the boost converter through a resistive element.

In Example 11, the resistive element of any one or more of Examples 1-10 optionally includes a passive resistive element including a first terminal and a second terminal, wherein the receiving the input voltage of any one or more of Examples 1-10 optionally includes receiving a battery voltage at an input of the boost converter, wherein the providing the boosted output voltage of any one or more of Examples 1-10 optionally includes providing the boosted output voltage at an output of the boost converter using the received battery voltage and an inductor, wherein the output of the boost converter of any one or more of Examples 1-10 is optionally coupled to the first terminal of the resistive element, and wherein a first terminal of the shunt regulator of any one or more of Examples 1-10 is optionally coupled to the second terminal of the resistive element.

In Example 12, any one or more of Examples 1-11 optionally includes filtering the boosted output voltage using a resistor-capacitor (RC) circuit coupled to the shunt regulator, wherein the RC circuit of any one or more of Examples 1-11 optionally includes the resistive element.

In Example 13, the RC circuit of any one or more of Examples 1-12 optionally includes a filter capacitor, wherein the boost converter of any one or more of Examples 1-12 is optionally coupled to an inductor and a boost capacitor, wherein the receiving the input voltage of any one or more of Examples 1-12 optionally includes receiving a battery voltage less than 5 volts, wherein the providing the boosted output voltage of any one or more of Examples 1-12 optionally includes providing a boosted output voltage greater than 15 volts, and wherein the regulating the output ripple of the boosted output voltage of any one or more of Examples 1-12 optionally includes reducing the output ripple to less than 500 microvolts.

In Example 14, the boost capacitor and the filter capacitor of any one or more of Examples 1-13 are optionally at least one of 0402 or 0201 case size components, wherein 0402 case size components have a dimension of 0.6 mm by 0.3 mm and 0201 case size components have a dimension of 1.0 mm by 0.5 mm.

In Example 15, the inductor of any one or more of Examples 1-14 is optionally at least one of a 0402 or a 0201 case size component.

In Example 16, any one or more of Examples 1-15 optionally includes controlling the boost converter using information from the shunt regulator.

In Example 17, the controlling the boost converter of any one or more of Examples 1-16 optionally includes comparing a current through the shunt regulator to a reference.

In Example 18, the providing the ultra-low ripple boosted output voltage of any one or more of Examples 1-17 optionally includes providing a boosted output voltage between 16 and 20 volts using the boost converter and regulating the output ripple of the boosted output voltage to be less than 500 microvolts using the shunt regulator.

In Example 19, a system includes a boost converter, including an inductor and a boost capacitor, the boost converter configured to receive a battery voltage at an input and to provide a boosted output voltage at an output using the inductor and the boost capacitor, a passive resistive element having a first terminal and second terminal, the first terminal of the passive resistive element coupled to the output of the boost converter, a shunt regulator coupled to the second terminal of the passive resistive element, the shunt regulator configured to regulate an output ripple of the boosted output voltage, a resistor-capacitor (RC) circuit including the passive resistor and a filter capacitor, the RC circuit configured to filter the boosted output voltage, a feedback circuit including a comparator configured to compare a current through the shunt regulator to a reference, wherein the feedback circuit configured to control the boost converter using information from the comparator.

In Example 20, the boost capacitor, the filter capacitor, and the inductor of any one or more of Examples 1-19 are optionally at least one of 0402 or 0201 case size components, wherein 0402 case size components have a dimension of 0.6 mm by 0.3 mm and 0201 case size components have a dimension of 1.0 mm by 0.5 mm, wherein the boost converter of any one or more of Examples 1-19 is optionally configured to receive an input voltage from a battery less than 5 volts and to provide a boosted output voltage greater than 15 volts, and wherein the shunt regulator and the RC circuit of any one or more of Examples 1-19 are optionally configured to reduce a ripple of the boosted output voltage to be less than 500 microvolts.

In Example 21, a system or apparatus can include, or can optionally be combined with any portion or combination of any portions of any one or more of Examples 1-20 to include, means for performing any one or more of the functions of Examples 1-20, or a machine-readable medium including instructions that, when performed by a machine, cause the machine to perform any one or more of the functions of Examples 1-20.

These non-limiting examples can be combined in any permutation or combination.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. An apparatus configured to provide an ultra-low ripple boosted output voltage, comprising:
a boost converter configured to receive an input voltage and to provide a boosted output voltage; and
a shunt regulator coupled to the output of the boost converter through a resistive element, the shunt regulator configured to regulate an output ripple of the boosted output voltage.

2. The apparatus of claim 1, including the resistive element,
wherein the resistive element includes a passive resistive element including a first terminal and a second terminal,
wherein the boost converter includes an input configured to receive a battery voltage and an output configured to provide the boosted output voltage using an inductor,
wherein the output of the boost converter is coupled to the first terminal of the resistive element, and
wherein a first terminal of the shunt regulator is coupled to the second terminal of the resistive element.

3. The apparatus of claim 1, including a resistor-capacitor (RC) circuit coupled to the shunt regulator, the RC circuit configured to filter the boosted output voltage,
wherein the RC circuit includes the resistive element.

4. The apparatus of claim 3, wherein the RC circuit includes a filter capacitor,
wherein the boost converter is coupled to an inductor and a boost capacitor,
wherein the boost converter is configured to receive an input voltage from a battery less than 5 volts and to provide a boosted output voltage greater than 15 volts, and
wherein the shunt regulator is configured to reduce a ripple of the boosted output voltage to be less than 500 microvolts.

5. The apparatus of claim 4, wherein the boost capacitor and the filter capacitor are at least one of 0402 or 0201 case size components,
wherein 0402 case size components have a dimension of 0.6 mm by 0.3 mm, and
wherein 0201 case size components have a dimension of 1.0 mm by 0.5 mm.

6. The apparatus of claim 5, wherein the inductor is at least one of a 0402 or a 0201 case size component.

7. The apparatus of claim 1, including a feedback circuit configured to control the boost converter using information from the shunt regulator.

8. The apparatus of claim 7, wherein the feedback circuit includes a comparator configured to compare a current through the shunt regulator to a reference.

9. The apparatus of claim 1, wherein the ultra-low ripple boosted output voltage includes an output voltage between 16 and 20 volts with a ripple less than 500 microvolts.

10. A method for providing an ultra-low ripple boosted output voltage, comprising:
receiving an input voltage and providing a boosted output voltage using a boost converter; and
regulating an output ripple of the boosted output voltage using a shunt regulator coupled to the output of the boost converter through a resistive element.

11. The method of claim 10, wherein the resistive element includes a passive resistive element including a first terminal and a second terminal,
wherein the receiving the input voltage includes receiving a battery voltage at an input of the boost converter,
wherein the providing the boosted output voltage includes providing the boosted output voltage at an output of the boost converter using the received battery voltage and an inductor,
wherein the output of the boost converter is coupled to the first terminal of the resistive element, and
wherein a first terminal of the shunt regulator is coupled to the second terminal of the resistive element.

12. The method of claim 10, including filtering the boosted output voltage using a resistor-capacitor (RC) circuit coupled to the shunt regulator,
wherein the RC circuit includes the resistive element.

13. The method of claim 12, wherein the RC circuit includes a filter capacitor,
wherein the boost converter is coupled to an inductor and a boost capacitor,
wherein the receiving the input voltage includes receiving a battery voltage less than 5 volts,
wherein the providing the boosted output voltage includes providing a boosted output voltage greater than 15 volts, and
wherein the regulating the output ripple of the boosted output voltage includes reducing the output ripple to less than 500 microvolts.

14. The method of claim 13, wherein the boost capacitor and the filter capacitor are at least one of 0402 or 0201 case size components,
wherein 0402 case size components have a dimension of 0.6 mm by 0.3 mm, and
wherein 0201 case size components have a dimension of 1.0 mm by 0.5 mm.

15. The method of claim 13, wherein the inductor is at least one of a 0402 or a 0201 case size component.

16. The method of claim 10, including controlling the boost converter using information from the shunt regulator.

17. The method of claim 16, wherein the controlling the boost converter includes comparing a current through the shunt regulator to a reference.

18. The method of claim 10, wherein the providing the ultra-low ripple boosted output voltage includes providing a boosted output voltage between 16 and 20 volts using the boost converter and regulating the output ripple of the boosted output voltage to be less than 500 microvolts using the shunt regulator.

19. A system comprising:
a boost converter, including an inductor and a boost capacitor, the boost converter configured to receive a battery voltage at an input and to provide a boosted output voltage at an output using the inductor and the boost capacitor;
a passive resistive element having a first terminal and second terminal, the first terminal of the passive resistive element coupled to the output of the boost converter;
a shunt regulator coupled to the second terminal of the passive resistive element, the shunt regulator configured to regulate an output ripple of the boosted output voltage;
a resistor-capacitor (RC) circuit including the passive resistor and a filter capacitor, the RC circuit configured to filter the boosted output voltage; and
a feedback circuit including a comparator configured to compare a current through the shunt regulator to a reference, wherein the feedback circuit configured to control the boost converter using information from the comparator.

20. The system of claim 19, wherein the boost capacitor, the filter capacitor, and the inductor are at least one of 0402 or 0201 case size components,
wherein 0402 case size components have a dimension of 0.6 mm by 0.3 mm,
wherein 0201 case size components have a dimension of 1.0 mm by 0.5 mm,
wherein the boost converter is configured to receive an input voltage from a battery less than 5 volts and to provide a boosted output voltage greater than 15 volts, and
wherein the shunt regulator and the RC circuit are configured to reduce a ripple of the boosted output voltage to be less than 500 microvolts.
